(19) United States
(12) Patent Application Publication
(10) Pub. No.: US 2013/0071575 A1
(43) Pub. Date: Mar. 21, 2013

(54) COMPONENT MANIPULATOR FOR THE DYNAMIC POSITIONING OF A SUBSTRATE, COATING METHOD, AS WELL AS USE OF A COMPONENT MANIPULATOR

(71) Applicant: Markus Müller, Dintikon (CH)

(72) Inventor: Markus Müller, Dintikon (CH)

(21) Appl. No.: 13/419,770

(22) Filed: Mar. 14, 2012

(30) Foreign Application Priority Data
Mar. 17, 2011 (EP) 11158579.0

(51) Int. Cl. B65G 49/00

(52) U.S. Cl. CPC B65G 49/00
USPC 427/446; 118/723 R; 414/754

(57) ABSTRACT

The invention relates to a component manipulator for the dynamic positioning of a substrate to be treated in a thermal treatment process, wherein the component manipulator includes a main drive axle rotatable about a main rotary axis, a connection element and a substrate holder connectable to the connection element. In accordance with the invention the connection element is a ceramic connection element and a connection segment of the substrate holder is connectable to the connection element in a pull resistant and rotationally fixed manner by means of a plug and rotate connection with regard to a connection axis (V) of the plug and rotate connection and the substrate holder (5) is arranged rotatable about the connection axis (V). The invention further relates to a coating method, to a coating apparatus, as well as to the use of a component manipulator.

The invention relates to a component manipulator for the dynamic positioning of a substrate to be treated in a thermal treatment process, to a coating method for use of a component manipulator, as well as to the use of a component manipulator for coating a substrate by means of a thermal coating method in accordance with the preamble of the independent claim of the respective category.

The coating of surfaces of various work pieces has a nearly innumerous number of applications and is correspondingly of high economic importance in the industrial technology. In this respect coatings can advantageously be applied onto the most different substrates for very different reasons. For example, wear protection layers on mechanically strongly loaded parts, such as for example, on running surfaces of cylinders or of piston rings of internal combustion engines or compressors play a large role. Beside the wear resistance also further requirements, such as good sliding properties, this means good tribological properties or also excellent dry rolling properties are placed on such parts. In particular different thermal spray methods, in particular the known plasma spray method have been proven highly successful for such and similar requirements.

For the generation of hard layers on highly loaded tools, in particular coatings are manufactured very successfully by arc vaporization, PVD or CVD processes on chip removing tools such as milling machines, drills etc. Specifically the use of the last mentioned process is, however, also very widely distributed also in other fields of application, for example, for the coating of jewelry or watch housings or for the application of protective layers or simply for the embellishment of utensils.

Also other method, such as for example, gas nitriding are well established methods which, amongst other things, are of large importance with regard to corrosion protection.

In this respect the coating of very large area work pieces or of components having a complicated surface geometry is generally very problematic.

Generally speaking, thermal spraying has also established itself in various variants also for these generally more problematic cases, in particular since thermal spraying has been established for a long time in the manufacturing of individual parts and in the industrial serial production. The most common spray methods, which are, in particular also used in the serial production of the coating of surfaces of substrates in large numbers, are, for example, flame spraying with a spray powder or a spray wire, arc spraying, high velocity flame spraying (HVOF), flame shock spraying or plasma spraying. The aforementioned list of thermal spray methods is surely not conclusive. The person of ordinary skill in the art rather knows a large number of variants of the listed methods, as well as further methods, for example, special procedures such as flame spray welding. Also the so-called “cold gas spraying” must be mentioned in this connection.

In this respect thermal spraying has been made available to further areas of application. One can generally conclude that thermal spraying as a surface spray method is the coating technique with probably the largest areas of application with regard to its field of application. A limiting of the fields of applications of the aforementioned spray methods does not necessarily appear advisable, since the fields of application can overlap in this connection.

In this respect it has been a problem for a long time to provide components with a complicated surface geometry in sufficient uniformity. A typical example for such parts are turbine vanes for land supported turbines or air-supported turbines and/or power units of air vehicles of all kind.

A break-through was made in this context by the method suggested, for example, in EP 0 776 594 B1 by Sulzer Metco by providing a thermal low pressure process (“LPPSmethod”) which permits the manufacture of uniform coatings not only on geometrically complicated components, but also on large areas, for example on sheet metal parts, by means of a wide plasma current. This, on the one hand, is achieved by the geometric design of the spray gun, with it, however, also being essential that a significant pressure difference is present between the interior and the exterior of the spray gun. The work piece or at least the surface region to be coated of the work piece is in this connection present in a coating chamber, in which a negative pressure is produced with regard to the interior of the spray gun, for example, a negative pressure of less than 100 mbar, while a pressure of approximately, for example, 1000 mbar is present in the spray gun, i.e. approximately environmental pressure is present. By means of setting such a pressure gradient between the interior of the spray gun and the coating chamber a broad and long coating beam can be generated by means of which the surface of the work piece can be coated in a so far non-achievable uniformity.

In this respect an essential advantage of this method consists therein that coatings are also possible to a certain extent in regions which lie in the “shadow” of the coating beam and for this reason are generally not within reach on use of conventional plasma coating methods; this means that such components cannot be provided with coatings sufficiently uniformly at all surfaces by means of conventional coating methods and, in particular the coatings at those surfaces which lie in a shaded region with respect to the coating beam are not generated in a sufficient quality.

In this respect the basic principle has been substantially further developed in the meantime. EP 1 479 788 A1 for example shows a hybrid method which is based on the fundamental method of EP 0776 594 B1.

In this connection these methods are particularly suitable to apply different metallic or non-metallic coatings, in particular also ceramic, carbidic or nitridic layer components in thin layers.

In particular for the coating of turbine vanes the so-called LPPS-thin film-process (PS-TF) of Sulzer Metco has established itself in this connection, which at the time positively revolutionized the low pressure plasma spraying. In this respect it is a conventional LPPS-plasma spray method which was changed from a procedural point of view. In this respect a space is flowed through by a plasma (“plasma flame” or “plasma beam”) is widened and expanded to a length of up to 2.5 m by a suitable setting of the spray parameters, in particular of the pressure parameters in the process chamber and in the plasma flame or the plasma beam itself. The geometric expansion of the plasma leads to a uniform expansion—a “defocusing”—of a powder beam which is injected into the plasma with a feed gas. The material of the powder beam which disperges to a cloud in the plasma and is partially or completely molten there arrives uniformly distributed on a broadly extended surface of a substrate. A thin layer arises on the substrate whose layer thickness can be smaller than 10 μm and which forms a dense cover thanks to the uniform distribution. By means of several applications of thin layers a thicker layer having particular properties can be manufactured which makes such a coating usable as a functional layer. For example, a porous layer can be manufactured by means of a multi-layer application, which is suitable as a support for catalytically active materials (see EP-1 034 843).

If we consider a turbine vane as an example then a functional layer which is applied onto the basic body forming the turbine layer is generally composed of many partial layers. For example, for a gas turbine (stationary gas turbine or airplane turbine) which is operated at high process temperatures, the vanes are coated with a first one or multi-layer partial layer which has a resistance to hot gas corrosion. A second coating, which is applied onto the first partial coating and for which the ceramic material is used forms a thermal barrier coating. The previously known LPPS plasma spray methods were particularly well suited for the manufacture of the first layer. The thermal barrier coating was so far advantageously generated in that a coating having a columnar microstructure arose. The so structured layer is composed of approximately cylindrical bodies or corpuscles whose central axes are aligned perpendicular to the substrate surface. Transfer regions, in which the density of the deposited material is smaller than in the corpuscles, limit the corpuscles laterally. A coating having such an anisotropic microstructure is a structure more tolerant to strain with regard to changing tensions which result due to repeatedly arising temperature changes. The coating reacts to the changing tensions in a generally reversible manner, this means without the formation of cracks, so that its lifetime can be considerably extended in comparison to the lifetime of a common coating which has no columnar microstructure.

The anisotropic microstructure is generatable by means of a thin film method which is a vapor deposition method. In this method which is referred to as “EB-PVD” (electron beam-physical vapor deposition), the substance to be deposited as the thermal barrier coating is brought into the vapor phase by means of an electron beam in a high vacuum and is evaporated from the vapor phase onto the component to be coated. If the process parameters are suitably selected then a columnar microstructure results. A disadvantage of this vapor deposition method is, amongst other things, the very high plant costs. In addition to this, on the manufacture of a coating including several partial layers the same plant cannot be used for both the LPPS plasma spray method and for the EB-PVD process. For this reason several work cycles have to be carried out for the coating.

This problem was satisfactory solved by Sulzer Metco for the first time by the invention in accordance with EP 1 495 151 B1, whereby a plasma spray method was made available for the first time, by means of which a thermal barrier coating was manufacturable and which permits the application of a coating onto a turbine vane in a work cycle which coating includes the thermal barrier coating as a partial layer.

This is achieved by a novel plasma spray method in which a material to be coated was sprayed onto a surface of a metallic substrate in the form of a powder beam, in particular onto a turbine vane. In this respect the coating material is injected into a plasma defocusing the powder beam at a low process pressure which is less than 100 mbar and is either partially or completely molten there. In this respect a plasma having a sufficiently high specific enthalpy is generated, so that a substantial part of the coating material, at least 5 percent by weight, is transferred into the vapor phase and an anisotropic structured layer is formed on the substrate. Elongate corpuscles, which form an anisotropic microstructure are aligned standing generally perpendicular to the substrate surface in this layer. Transfer regions poor in material bound the corpuscles against one another.

The method in accordance with EP 1 495 151 B1 in this respect has a further decisive advantage with regard to the known method by means of which a columnar structured layer is manufactured by means of EB-PVD: The process times for the same layer thickness are significantly shorter.

Meanwhile the method in accordance with EP 1 495 151 B1 of Sulzer Metco has been decisively improved and further developed and has been established on the market by way of the abbreviated designation PS-PVD in the meantime. Since the component manipulator described in the framework of this application can be advantageously used in connection with the claimed coating method, which is preferably the PS-PVD method known per se, this shall be explained in the following in detail, so that the following description of the PS-PVD method forms a part of the description of the present invention.

It is naturally understood that the component manipulator of the present invention can naturally be used in any thermal treatment process and thus in principle can also be used advantageously in any coating method.

PS-PVD, which is an abbreviation for “plasma spray-physical vapor deposition”, is a low pressure plasma spray technology for the deposition of coatings from the vapor phase. In this respect PS-PVD is a part of a family of new hybridic processes which the applicant has recently developed on the basis of the above described LPPS technology (Journal of Thermal Spray Technology, 502, vol. 19(1-2) January 2010). In this respect this family includes, beside PS-PVD, amongst other things, also “plasma spray-chemical vapor deposition” (PS-CVD) and “plasma spray-thin film” (PS-TF) processes. In comparison to conventional vacuum plasma spraying and/or to conventional LPPS processes these new processes are characterized by the use of a high energy plasma gun which is operated at a working pressure of less than 2 mbar. This leads to an unconventional plasma beam characteristic which can be used for the manufacture of unique specific coatings. An important new property of the PS-PVD process is the possibility of forming coatings not only from a molten fluid material, in that the layers are built up by so-called liquid “splats” which solidify on being incident at the substrate. However, PS-PVD also permits the build-up of layers directly from the vapor phase. Thus PS-PVD fills the void between conventional PVD techniques and the standard techniques of thermal spraying. This possibility of transferring the coating material into the vapor phase and thereby to directly deposit layers from the vapor phase opens up completely new possibilities of building up other unique layers and/or layer systems having a novel structure.

The properties of these new layer structures are considerably superior in comparison to the so far known layers in many aspects, in particular to the layers which are manufactured by means of EP-PVD. It is namely common for all thermal spray processes that, as already mentioned, the layers of molten material, of the so-called “splats”, are thus finally formed by a freezing process of the liquid spray material on the surface of the substrate. This is in contrast to the classical PVD processes, in which the coatings are formed on the substrate in a process chamber from the vapor phase, in which the coating material is transferred into the vapor phase in the process chamber at low pressure of e.g. approximately 10⁻⁴ mbar. This means that the hot coating material is not deposited onto the cold substrate surface from the liquid phase, but it condenses from the vapor phase onto the substrate surface. This leads to very characteristic properties of the coating which could not be achieved with common thermal spray methods. PVD layers can be very homogeneous as is known per se, in this respect very thin, dense, hard and gas-tight or can have specific predeterminable microstructures.

The columnar structure of yttrium stabilized zirconium (YSZ), which is deposited by means of EP-PVD (electron beam-physical vapor deposition) is, for example, particularly suitable for thermal barrier coatings (TBC) which have to be very stress relieved and/or stress tolerant.

The decisive disadvantages of the PVD-method in comparison to the thermal spraying are the high investment cost and the low deposition rates and thus the high process costs. For this reason PVD processes are primarily used for very thin layers and in mass production. Or, however, also for the coating of very valuable or safety relevant parts such as, for example, of running vanes or guide vanes of turbines of air vehicles.

Moreover, only layers can be coated by means of conventional PVD techniques which are in a direct line of sight to the coating source, i.e. do not lie in a shaded region with regard to the coating source. For this reason it has so far always been difficult and/or formerly impossible, to coat components with undercuts or complex geometries, such as for example turbine vanes, with homogeneous layers of high quality and of predefined microstructure effectively and cost-efficiently.

For this reason it has been a long standing requirement in the state of the art to have an apparatus and a method available which unifies the advantages of thermal spraying and the PVD process in a single process. This has been achieved by Sulzer Metco by the recently developed PS-PVD process which is a further development of the original LPPS process and which provides a method for the first time by means of which one can coat from the vapor phase by means of thermal spraying, so that coatings of high quality with predefinable microstructure and with predefinable properties can be manufactured very efficiently at low cost and in large numbers. This new method is, in particular in the position to also coat surface regions uniformly and in the desired thickness and quality which lie in shaded regions with regard to the coating source, i.e. are not in the direct line of sight of the coating source.

In this respect the PS-PVD process is carried out similar to the LPPS process at a defined process atmosphere and at a reduced gas pressure with regard to the atmospheric environmental pressure, typically in an inert gas atmosphere, for example an argon gas in a process chamber. Typical process gas pressures lie between 0.5 mbar and 2 mbar. The plasma flame or the plasma beam is inflated, for example, to a length of more than 2 m and a diameter of 200 mm up to 400 mm by a reduced pressure the process chamber, wherein, on a suitable selection of the pressure parameter, also larger plasma flames are by all means settable. In particular a very homogeneous distribution of the temperature and the particle speed is achieved in the plasma flame through the inflation of the plasma flame or of the plasma beam, so that layers of very uniform thickness can also be generated on very complex components, such as for example, turbine vanes, also in shaded surface regions.

In this respect the surface of the substrate is preferably preheated and/or cleaned. This can, for example, take place by means of the plasma beam or by means of an arc process integrated into the process chamber.

Although the PS-PVD work pressure of, for example, 1 mbar is significantly higher than the work pressure of approximately 10⁻⁴ mbar, such as is used for classical PVD processes, the combination of low process pressure and high plasma energy and/or enthalpy in the plasma flame and/or the plasma jet leads to a defined evaporation of the powder injected into the plasma flame and for this reason permits a controlled deposition from the vapor phase in the PS-PVD process.

In contrast to this the transport of the evaporated material in the direction of the substrate surface is a diffusion process with limited transfer rate in an EB-PVD process and therefore finally is also a diffusion process with a limited growth speed of the surface layers to be applied. Different in the PS-PVD process which transports the evaporated coating material in a plasma jet at supersonic speed of approximately 2000 m/s up to 4000 m/s at a pressure of approximately 1 mbar and at a temperature of approximately 6.000 K to 10.000 K. This leads to high growth speeds of the layers at the substrate and the possibility of also coating undercuts or shaded areas of the substrate in a uniform high quality.

Therefore the PS-PVD process for the first time enables the coating also of very complexly formed parts, such as for example turbine vanes, in previously not known quality, automatically and in large numbers, for example, with thermal barrier coating systems efficiently.

However, an increasing cost pressure also requires further improvements here. An essential property of the above described process namely lies therein that the component to be coated must be tempered within certain boundaries more or less uniformly. This, for example, takes place in the known EP-PVD method by the fact that a heating is provided in the chamber walls of the process chamber in which the coating process is carried out which uniformly tempers the component to be coated from several sides within certain limits, which is naturally a further disadvantage of the EP-PVD method, since the relatively demanding heating must additionally be provided in the chamber wall and naturally also has to be operated. In the LPPS method generally and, in particular in the PS-PVD method the component is only preheated by the coating beam, which has the advantage that the additional heating in the chamber wall can be saved, but naturally also leads to a very inhomogeneous temperature field within the coating chamber. For this reason it is known that when the expansion of the component to be coated is such that it is no longer sufficiently homogeneously tempered by the coating beam, for example, when the expansion of the part to be coated is so large that the coating beam only partially covers and/or envelopes the surface of the component, to move the coating beam to and fro over the component in a predefinable angular region with sufficient speed, so that all surfaces of the component are subsequently scanned periodically by the coating beam during the coating, so that one after the other all surface regions are time and again subjected to the coating beam such that the overall surface, on the one hand is uniformly coated and, on the other hand, the component to be coated is sufficiently uniformly tempered or preheated within pre-definable parameter boundaries. This more or less periodic movement of the coating beam for the scanning over of the substrate to be coated is also frequently referred as a “sweeping” of the coating beam.

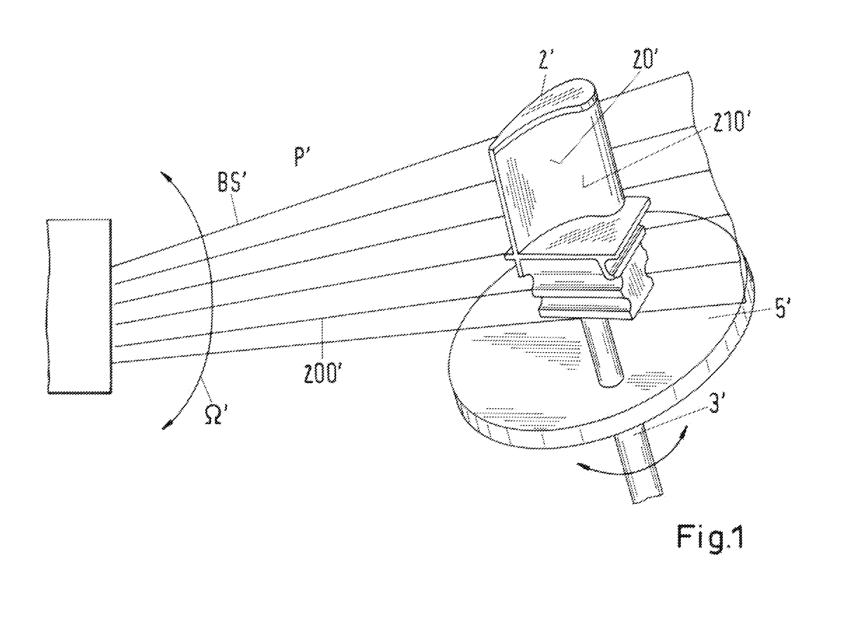

In order to improve the effect of the uniform tempering and coating it is also known to mount, for example a turbine vane, onto a rotatable substrate holder, so that the substrate is also rotated about an axis of rotation simultaneously with the sweeping of the coating beam, so that the coating beam is subsequently directly applied to the substrate from all sides. This apparatus known per se is again explained for reasons of clarity with reference to FIG. 1.

In FIG. 1 a method known from the prior art is schematically illustrated for the coating of a turbine vane of an airplane turbine.

It should be noted that for a better differentiation of the invention from the prior art the reference numerals in FIG. 1, which relate to a known method, are provided with an apostrophe, while the reference numerals in the remaining Figures, which relate to the invention, have no apostrophe.

FIG. 1 shows a method well known from the prior art for the manufacture of a functional structured layer 20′ on a substrate 2′ which in the present example is a turbine vane 2′ for an airplane, in which a coating material 200′ in the form of a coating beam BS′ is sprayed onto a surface 210′ of the substrate 2′ at a predefined low process pressure P′ by means of a plasma spray method in a process chamber, which for reasons of clarity is not illustrated in detail in FIG. 1. In this respect the coating material 200′ is injected at the low process pressure P′, which can, for example, be approximately 1 mbar, into a plasma defocusing the coating beam BS′ and is partially or completely molten there, wherein a plasma having a sufficiently high specific enthalpy is generated, so that a substantial as high as possible part of the coating material 200′ is transferred into the vapor phase and the structured layer 20′ is formed on the substrate 2′. To achieve an as uniform as possible coating of the turbine vane 2′ this is arranged on a substrate plate 5′ rotatable about a rotary axis 3′ and is turned in the coating beam BS′. At the same time the coating beam BS′ is sweeped in an angular region Ω′ to and fro over the turbine vane 3′ to be coated.

Unfortunately, however, it was so far only possible to coat at most a single not too large substrate in this manner by means PS-PVD.

Spatially expanded substrates which are so large that their surfaces are not completely captured by the coating beam on sweeping or which have an asymmetric geometry such that certain surface regions, for example, on rotating of the rotary plate so far away from the beam axis of the coating beam, so that the coating beam no longer arrives there, could so far not be satisfactory coated with the PS-PVD method. Since the angular region, over which the coating beam is maximally swept in the coating chamber is naturally limited and at the same time the substrate to be coated has to have a considerable separation distance to the spray gun, which generates the coating beam, it was generally considered among experts that several substrates which could theoretically be placed onto a rotary substrate holder could not be simultaneously coated with the known PS-PVD method in a work cycle.

Naturally even if all surfaces could be subsequently reached by the coating beam through a suitable rotation of the rotary substrate holder on a simultaneous suitable sweep movement of the coating beam, one was so far of the opinion that one could not apply any uniform layers on the substrate by means of a PS-PVD method.

In this respect the reason for this assumption has sound physical foundations. As was described above in the LPPS method, in particular in the PS-PVD method it is namely essential that the substrates must be preheated as uniformly as possible by the coating beam. This means that the substrate to be coated has to at least partially be substantially constantly completely subjected to the coating beam in the short time average. In this respect the time average means that, for example, on sweeping of the coating beam or on rotation of the substrate holder, certain surface regions of the substrate are not subjected to the coating beam for so short a time that the temperature of these surface regions only insignificantly reduces in comparison to the temperature of those surface regions which are subjected to the coating beam. Otherwise such large temperature gradients arise in the substrate, or the temperature of the surface region which are intermittently not subjected to the coating beam reduce so far, such that layers having the required high quality can no longer be applied.

In particular if the subjection to the coating beam is intermittently more or less removed from a substrate provided on the substrate holder, the corresponding substrates would cool down so far that when they are once again subjected to the coating beam for the coating, a coating according to the high quality requirements is no longer possible.

This negative effect is even massively amplified for very complexly shaped substrates which have very deep lying or nested undercuts or are complexly formed in a different manner, such as for example, double vanes for modern, extremely highly loaded airplane turbines, since, for example shaded surface regions are heated even less frequently or less long by the coating beam so that a sufficient uniform coating having the highest requirements with regard to the layer quality and/or the layer structure are no longer possible.

In this respect the previously mentioned problems are not only to be feared when one tries to simultaneously coat several substrates in one and the same coating beam.

Even if only a single substrate is arranged in the coating beam the above described problems still arise. An essential reason for this are the known substrate holders which only permit a very limited type of positioning of the substrate to be coated in the coating beam.

This is primarily in connection with the fact that the treatment of the substrate takes place at difficult environmental conditions. For example, the treatment infrequently takes place in a dusty environment, at high pressures or at low pressures and, in particular at high temperatures of up to 1000° C. or even higher.

For this reason the known substrate holders are of simple design with as few moveable parts as possible, since for example known bearings, which would be required to design the substrate holder such that the component is rotatable or pivotable about additional axes cannot be subjected to the aggressive environmental conditions or can only be subjected to the aggressive environmental conditions for a very short time, in particular to the high temperatures. However, since very long treatment times are frequently required on thermal coating, for example, the coating process can generally take an hour or longer, the substrate holder would then fail after a short time with known bearings for rotating or pivoting the substrate. For this reason so far only very simple substrate holders were available which only permit a dynamic position of the substrate in a very limited manner.

A further disadvantage of the known substrate holders is the lacking thermal decoupling of the substrate to be coated from the substrate holder. For example, on thermal coating this has the effect that a considerable and also frequently irregular temperature discharge from the substrate to be coated, i.e. for example a turbine vane to be thermally coated, takes place into the handling which supports the subject matter and guides the substrate holder via the substrate holder. This more or less uncontrollable temperature discharging in combination with lack of alignability and movability of the substrate with regard to the coating beam leads to massive losses in the layer quality and/or to high rejection rates and therefore to non-acceptably high costs.

For this reason it is the object of the invention to provide a component manipulator for the dynamic positioning of a substrate to be treated in a thermal treatment process, in particular a thermal spray process, by means of which the disadvantages of the substrate holders known from the prior art are avoided and by means of which it is, in particular possible to move the component during the treatment process about at least one axis, wherein the substrate to be treated is thermally decoupled from the component manipulator in a predefinable manner, or a thermal coupling and/or a heat flow of the substrate to be coated is settable, changeable and/or can be influenced by means of the component manipulator also during the coating process.

A further object of the invention is to provide a coating method as well as the use of a component manipulator in which the problems known from the prior art are avoided in order to, in particular also simultaneously treat several substrates ideally, so that surface layers of very high and uniform quality are deposited cost and time efficiently also onto several substrates simultaneously and/or on very large substrates and/or onto substrates of very complex geometry by means of an LPPS method, in particular by means of a PS-PVD process.

The subject matter of the invention satisfying this object are characterized by the independent claims of the respective category.

The respective dependent claims relate to particularly advantageous embodiments of the invention.

The invention thus relates to a component manipulator for the dynamic positioning of a substrate to be treated in a thermal treatment process, wherein the component manipulator includes a main drive axle rotatable about a main rotary axis, a connection element and a substrate holder connectable to the connection element. In accordance with the invention the connection element is a ceramic connection element and a connection segment of the substrate holder is connectable to the connection element in a pull-resistant and rotationally fixed manner by means of a plug and rotate connection with regard to a connection axis of the plug and rotate connection and the substrate holder is arranged rotatable about the connection axis.

Essential for the invention is that the connection element is a ceramic connection element. Because the connection element is made of a very poorly conducting ceramic material, the substrate holder and therefore the substrate to be coated arranged thereon is thermally decoupled very well from the component manipulator in accordance with the invention. For this reason it is possible for the first time, to reduce, for example, a heat flow from a substrate to a component manipulator to a small predefinable degree on thermal coating, whereby the temperature flow simultaneously is also uniformly discharged from the substrate to be treated, i.e. for example a turbine vane to be thermally coated, to the component manipulator via the substrate holder, so that the damaging uncontrollable temperature flows known from the prior art do not occur and the layer quality is significantly improved already due to this effect, to reduce the rejection rates and therefore to arrive at acceptable cost.

Because the ceramic connection element massively reduces the heat flow from the substrate into the component manipulator via the substrate holder, it is also possible for the first time to provide a drive unit and/or transmission unit by means of which the substrate holder is rotatable about the connection axis without which the transmission unit being influenced or even destroyed in the operating state due to the excessive influence of heat. In this respect the invention, in particular relates to a component manipulator having a 3-fold planetary transmission. This is of large importance, in particular for such specific embodiments in which a plurality of connection elements are simultaneously provided at the component manipulator for the reception of several substrate holders. In this case all connection elements can simultaneously be driven via the single main drive axle by means of a transmission unit provided at the component manipulator and can be displaced into rotation about the connection axis, so that, for example, on thermal coating of several substrates, these are rotatable in the coating beam, whereby a particularly even uniform coating of so far non achievable quality is producible.

Because the connection segment for the substrate holder is connectable to the connection element in a pull-resistant and rotationally fixed manner by means of a plug and rotate connection with regard to a connection axis of the plug and rotate connection the substrate holder can very simply be exchanged without complex mounting work having to be carried out at the component manipulator. In a particularly preferred embodiment the plug and rotate connection is designed in the form of a bayonet closure mechanism as is known per se.

In a preferred embodiment a base plate is provided which is rotationally fixedly connected to the main drive axle for receiving the connection element with the substrate holder at which one or more connection elements can simultaneously be provided, preferably but not necessarily, for example, three connection elements can simultaneously be provided, so that several substrates can simultaneously be provided at one and the same component manipulator. The plurality of connection elements is in this respect particularly advantageously provided at the base plate with regard to the main rotary axis eccentrically, so that, in the operating state, for example during a coating process, the substrates arranged at the substrate holders can be brought into contact with different regions of the coating beam by rotating about the main drive axis, whereby, in particular the uniformity of the coating of the substrates can be significantly improved.

In order to, for example, further improve the layer quality of the substrate on thermal coating, the connection element can be in connection with a contact element via a drive unit for the rotation about the connection axis of the substrate holder, this means for the rotary drive of the substrate holder about the connection axis of the substrate holder, wherein in a particularly preferred embodiment, the main drive axle of the component manipulator is rotatably arranged with regard to the contact element.

In this respect in an embodiment particularly relevant for practice the contact element is a toothed wheel arranged with a shaft jacket stationary with regard to the main drive axle which is toothed for the drive of the connection element by means of the drive unit.

In this respect it is particularly preferred that the connection axis of the plug and rotate connection is tilted at a predefinable tilt angle with regard to the main rotary axis, so that, for example, on the one hand, an asymmetric movement of the substrate to be coated in the coating beam is possible, so that also geometrically asymmetrically designed components which are possibly provided with undercuts, such as for example turbine vanes, are coatable on all surfaces very uniformly, in particular also at the surfaces of poorly accessible undercuts. Furthermore, it is possible, as will be described further below that because the substrates are tilted relative to one another and simultaneously rotate about their respective axis of rotation against one another, different substrate sections of two substrates subsequently face one another and that coating material from a substrate surface can be reflected onto the surface of a different substrate, so that also coating effects in a direction are possible which does not correspond to the direction of the coating beam.

In this respect the connection element can be supported in a bearing housing by a bearing element, wherein three bearing elements are preferably provided in the bearing housings, which form a three-point bearing.

In an embodiment particularly relevant for practice the base plate has preferably been rotatably fixedly connected to the main drive axle via a connection element in this connection for the supply of a cooling liquid to the substrate. In practice the cooling fluid can be supplied, for example, from the connection element to the connection element and to the connection segment of the substrate holder via a cooling distributor arranged at the base plate and a cooling line. In this respect the bearing element can also be cooled by means of an indirect contact with the cooling fluid in an embodiment particularly relevant for practice.

In order to ensure a secure connection of the substrate holder and/or of the connection segment to the connection element, the connection segment can be secured against a rotation with regard to the connection element by means of a security against rotation, wherein the security against rotation, is a locking pin, in particular preferably is a ceramic locking pin which can, for example, be secured by means of a safety tape provided at the connection element.

In this respect the connection element is, for example, encapsulated in a capsule for protection against temperature radiation, for protection against a coating beam or for protection against other damaging influences which can effect the connection element in the operating state.

The invention further relates to a coating method on use of a component manipulator, as well as to the use of a component manipulator of the invention, wherein the substrate is, in particular a turbine vane for an airplane turbine, for a gas turbine, for a vapor turbine or for a water turbine.

In this respect the coating method in accordance with the invention, in particular relates but not only relates to a coating method for the manufacture of a functional structured layer on a substrate. In this respect a coating material is sprayed onto a surface of a substrate in the form of a coating beam in a process chamber at a predefined low process pressure by means of a plasma spray method, wherein the coating material is injected into a plasma defocusing the coating beam at a low process pressure which is less than 200 mbar, wherein a plasma with sufficiently high specific enthalpy is generated so that a substantial part of the coating material, a part of at least 5 percent by weight of the amount of the coating material, is transferred into the vapor phase and the structured layer is formed on the substrate. In this respect the substrate to be coated is arranged with the substrate holder rotatable about a main rotary axis, such that a first surface of the substrate and a second surface of the substrate are aligned with regard to one another, so that at least a part of the coating material transferred into the vapor phase is deflected from the first surface of the substrate onto the second surface of the substrate on plasma spraying.

Important for the coating method of the present invention are in this respect, amongst other things, the following effects which can be realized for the first time by the component manipulator in accordance with the invention due to the dynamic positionability of the substrate, by means of the component manipulator, for example in a coating beam:

On the one hand, it is possible to substantially maintain the preheating temperature of the substrate in the predefined technically required boundaries also at those surfaces which at least intermittently are not or are not directly subjected to the coating beam, as the corresponding surfaces are intermittently or partially turned out of the influential region of the coating beam, for example, through the rotation of the substrate holders at least in certain cases. This positive effect of the maintenance of a uniformly distributed preheating temperature over the substrate is even supported and amplified by the very good thermal decoupling which the ceramic connection element enables for the first time.

An analog advantage consists for those surfaces which, for example, for geometric reasons are never or insufficiently subjected to the coating beam, as the corresponding surfaces of the substrate are shaded completely or partially from the coating beam, for example, due to undercuts or through further substrates arranged at the substrate holder. This negative shading effect known from the prior art can indeed be prevented for the first time through the use of the component manipulator in accordance with the invention in the most cases. Since namely the substrate, for example, due to the tilted arrangement of the substrate holder and/or due to the rotation of the substrate about two different rotary axis, is namely simultaneously positionable about the main rotary axis and the connection axis, extremely flexibly and dynamically in the coating beam. It is naturally understood that for extremely complicated substrate geometries the previously mentioned shading effect can never be completely excluded.

It is achieved by means of the invention that also such surfaces can be maintained at the required pretreatment temperature and in that two surfaces of one or two substrates are arranged at the substrate holder with regard to one another, such that a part of the coating material which is present in the vapor phase is deflected and/or reflected from a first surface to a second surface, whereby hot coating vapor is incident also at those surfaces in a sufficient amount which are not subjected to the coating beam for a considerable time period or even never.

In this respect a “considerable time period” is to be understood as a time period which is so long that the substrate, at least in regions of the surfaces not subjected to the coating beam, is cooled down so strongly without the reflection effect in accordance with the invention and/or which never achieves the required preheated temperature, so that when the corresponding surfaces are once again subjected to the coating beam, a coating, at least in the required quality, would no longer be possible. In this respect the “considerable time period” is massively increased, since due to the thermal decoupling via the ceramic connection element the heat discharge is slowed down extremely on the use of a component manipulator in accordance with the invention. This means that the aforementioned problem is already significantly alleviated by the ceramic connection element, apart from the reflection effect in accordance with the invention.

On the other hand, substrates which are very complicated from a geometric point of view which for example, have very significant undercuts, whereby, for example, surfaces arise which normally would not be subjected to the coating beam, are not only sufficiently preheated, but can even also be coated by use of the method in accordance with the invention.

At this point it should be noted that specifically the different LPPS methods are known to also coat shaded surfaces in principle, i.e. that surfaces which are not directly subjected to the coating beam can, in principle, be coated. In contrast to other thermal coating methods, such as for example the conventional plasma spraying or flame spraying, in which the surfaces to be coated always have to be directly subjected to the coating beam. The possibility of the coating of shaded surface regions by means of LPPS is in this connection already explained in EP 2 025 772 A1 with reference to the example of a single turbine segment which respectively includes several turbine vanes and, for example, forms a double vane for highly loaded airplane turbines.

However, also the capability of the LPPS method, in particular of the PS-PVD method naturally has its limits. In particular then when several substrates are simultaneously arranged at a substrate holder which are also rather complexly formed, such as for example, the aforementioned double vanes for highly loaded airplane turbines no longer all surfaces of the substrates to be coated can be coated uniformly and in the required quality with the coating methods known in the prior art.

Through the arrangement in accordance with the invention of the substrates to be coated at the component manipulator several significant problems from the prior art are therefore simultaneously solved

On the one hand, it is prevented that the substrate or parts of the substrate are cooled down to an unallowed level, when, for example, they are constantly or at least intermittently removed from the direct subjection through the coating beam through a rotation of the substrate holder.

Secondly, surface regions of the substrate which could not be sufficiently preheated without the application of the method in accordance with the invention can be brought to the required preheating temperature without a problem, even if they are never subjected to the coating beam during the overall coating process. For this purpose generally no additional heating is by the way required like, for example, for an EP-PVD method, in which an additional heating must necessarily be provided in the chamber wall of the coating chamber.

And thirdly through the use of the method in accordance with the invention it is possible for the first time to coat the aforementioned surfaces and therefore the overall surfaces to be coated of the substrates uniformly and in the desired high quality. Furthermore, it is possible for the first time by means of the method of the present invention to simultaneously arrange a plurality of substrates, in particular substrates which are also arranged at small separation distances from one another at one and the same substrate holder and to coat these in a single work cycle. Therefore, the coating method of the present invention is extremely efficient in comparison to the methods known from the prior art in which only one single complicated substrate can be respectively coated simultaneously in a work cycle.

In this respect it must be emphasized that the effect in accordance with the invention cannot be achieved either with the classical PVD method nor with a classical thermal spray method nor with the well known EP-PVD method and insofar is completely unexpected and surprising. Thus none of the aforementioned known methods could have contributed to the solution of the object of the invention or even provide a single indication thereto. It is namely a recognition of the present invention that essentially two specific properties of the LPPS method in general and of the PS-PVD method in particular are required so that the method in accordance with the invention can actually be successfully used for the coating of complexly formed substrates or for several substrates simultaneously.

In contrast to the method in accordance with the invention, both for classical PVD methods and also for EP-PVD processes, the transport of the evaporated material in the direction towards the substrate surface is a diffusion process, i.e. a process which is not directed or if at all has a weakly directed character. Thus, also the reflection processes which possibly, if at all, arise at the surfaces of the substrates to be coated are substantially undirected, i.e. they have a more or less diffuse characteristic. It is evident that no specific and no sufficient heating and/or coating of shaded parts of the substrate surface is thereby possible. It is indeed known from a classical PVD and/or from an EB-PVD process to use a rotatable substrate plate which can simultaneously be loaded with several substrates. However, this does not specifically serve to set a reflection of a directed coating beam, as is the case with the method in accordance with the invention, but merely serves the purpose of compensating a certain inhomogeneity of the diffuse distribution of the vapor of the coating material in the process chamber.

On classical thermal coating, such as for example on classical plasma coating, at comparatively high process pressures, such as, for example, on plasma spraying at atmospheric pressure or on flame spraying a directed coating beam is indeed used and it is also known to use a rotary substrate holder which is simultaneously loaded with several substrates. However, also here the effect in accordance with the invention is generally not possible. In the aforementioned thermal spray processes, the coating material is namely practically incident more or less molten, i.e. in the more or less liquid, state at the substrate surface and thus is not incident at the substrate surface in the vapor phase, as is the case in the method in accordance with the invention. This is specifically the characteristic property of this known coating processes. As was previously mentioned in the introduction with regard to these known methods the coatings are formed by so-called liquid “splats” which solidify from the melt at the substrate on incidence thereon and are not formed by deposition of vapor-like material. It is naturally understood that if substantially liquid material is incident on the surface of the substrate to be coated, practically no reflection of the liquid drops takes place. This namely only condenses on striking the relatively cool surface of the substrate instantaneously to solid “splats” and adheres to the surface, so that a reflection is practically excluded.

In practice, at least one substrate including the first surface and at least a second substrate including the second surface is advantageously arranged and aligned at the substrate holder with regard to one another such that at least a part of the coating material transferred into the vapor phase is deflected and/or reflected from the first surface of the first substrate onto the second surface of the second substrate on plasma spraying, so that the second surface of the substrate is coated and/or preheated by the coating material deflected and/or reflected from the first surface of the first substrate.

In this respect it is preferred if an amount of vapor-like coating material which is deflected and/or reflected from the first surface onto the second surface is set such that the second surface is maintained at a predefinable surface temperature when the second surface is no longer directly subjected to the coating beam. In this respect several measures are possible by means of which the amount of deflected and/or reflected coating material can be suitably set. Thus, for example, the orientation of the first surface with regard to the second surface can be correspondingly optimized. Or different spray parameters, such as the heating power of the plasma, the process pressure in the process chamber, the ultrasonic speed of the coating beam or other spray parameters can be correspondingly set.

Also the rotatable substrate holder can be rotated about the main rotary axis and/or about the connection axis at a predetermined set or variable rotary speed and/or its rotary speed can be set or regulated such that the amount of deflected and/or reflected coating material or any different coating parameter is optimized.

Preferably the coating beam is pivoted to and fro over the substrate to be coated for a predefined spatial angular region in a manner known per se, which is also referred to as “sweeping” and has already been described in detail in the introduction for the mentioned purposes or for other purposes, for example, to uniformly temper the substrates to a predefined temperature.

Also a separation distance between the component manipulator and a plasma source generating the plasma can be changed in a predefined path interval. This can, for example, take place in that the position of the plasma source and/or the position of the component manipulator is changed such that the mutual separation distance between the component manipulator and the plasma source and/or the spray gun including the plasma source is changed.

Naturally it is also possible that a component manipulator is pivoted as a whole with regard to the coating beam in a predefined pivot region.

In this respect the process pressure in the coating chamber is frequently selected in practice to be less than 20 mbar, preferably less than 10 mbar in particular between 0.1 and 2 mbar.

In this respect the coating beam is generally operated at a supersonic speed having a sonic speed between 1,500 m/s and 3,000 m/s, and is preferably operated at approximately 2,000 m/s and/or the coating beam has a temperature between 4,000 K and 20,000 K, preferably has a temperature between 6,000 K and 10,000 K.

For most cases relevant in practice, the coating material is provided in a manner known per see in form of a spray powder in this connection.

In this respect the process parameters and/or the geometric parameters described above of the coating apparatus are set such that more than 10 percent by weight parts of the coating material are transferred into the vapor phase, preferably more than 50 percent by weight, in particular more than 80 percent by weight are transferred into the vapor phase in a preferred embodiment.

In this respect the method in accordance with the invention is particularly suitable to simultaneously coat a plurality of turbine vanes, in particular a plurality of double vanes in a coating process, wherein the structured layer is frequently a thermal barrier coating known per se in practice.

The invention further relates to a coating apparatus for carrying out one of the above-described methods in accordance with the invention for the manufacture of a functional structured layer on a substrate. In this respect the coating apparatus in accordance with the invention includes a process chamber in which a coating material is sprayable onto the surfaces of a substrate in the form of a coating beam at a predefinable low process pressure by means of a plasma spray method, wherein the coating material is injectable into a plasma defocusing coating beam at a low process pressure, which is less than 200 mbar, and is partially or completely meltable there. In this respect a plasma source and/or a spray piston including a plasma source is/are provided by means of a which a plasma with a sufficiently high enthalpy is generatable, so that a substantial part of the coating material, a part of at least 5 percent by weight of the amount of the coating material, is transferable into the vapor phase and the structured layer is formable on the substrate. In accordance with the invention a component manipulator in accordance with the present invention is provided for the dynamic positioning of the substrate to be treated.

In this respect the coating apparatus in accordance with the invention is preferably configured with the component manipulator such that the substrate to be coated can be arranged at the component manipulator, such that a first surface of the substrate and a second surface of the substrate can be aligned with regard to one another at the substrate holder, so that during a coating process at least a part of the coating material transferred into the vapor phase is deflected and/or reflected from the first surface of the substrate onto the second surface of the substrate on plasma spraying.

It is naturally understood that in specific embodiments the coating apparatus in accordance with the invention and/or the component manipulator in accordance with the invention can be configured from a construction point of view so that also other method variants, such as those described above, can also be carried out.

In the following the invention will be explained in detail with reference to the drawing. There is shown:

FIG. 1 a method for the coating of a turbine vane of an airplane power plant known from the prior art;

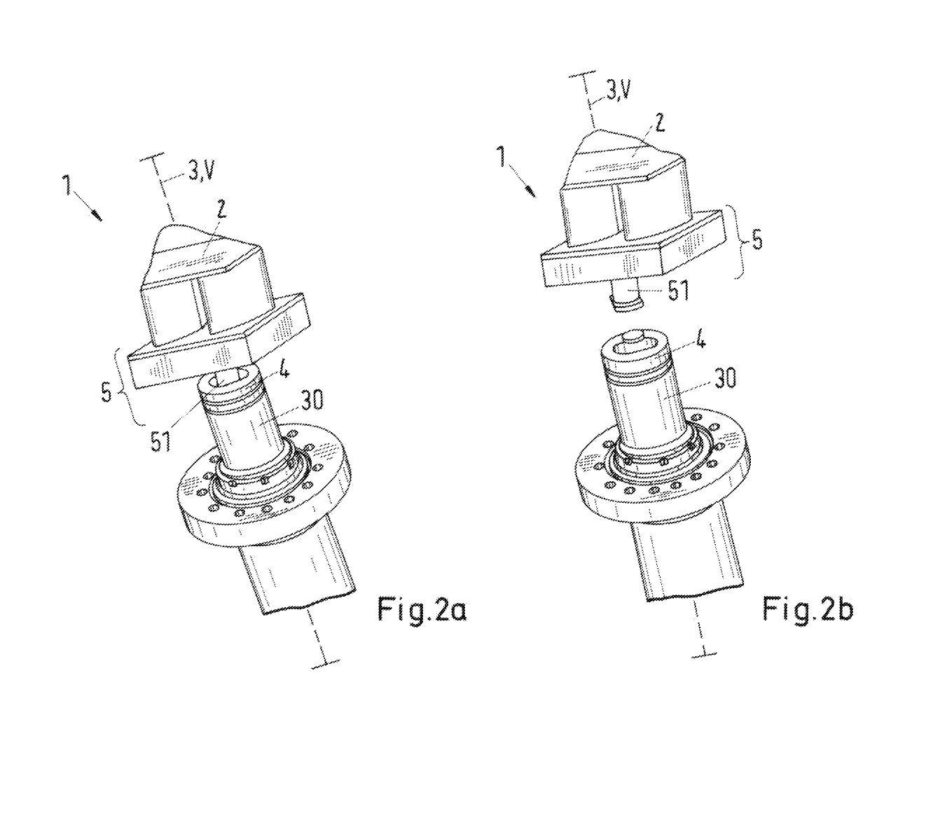

FIG. 2a a first very simple embodiment of a component manipulator in accordance with the invention;

FIG. 2b the embodiment in accordance with FIG. 2a in a demounted state;

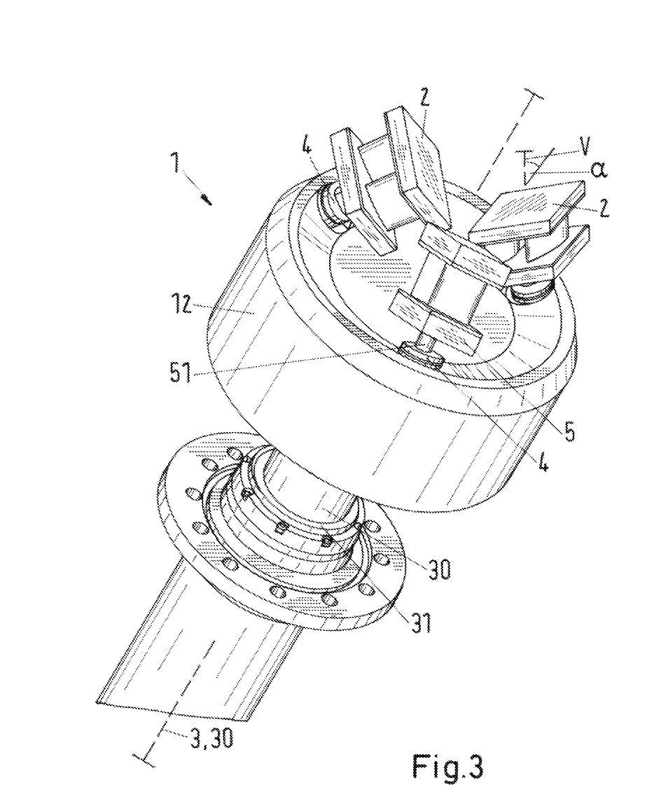

FIG. 3 a particularly preferred embodiment of a component manipulator in accordance with the invention;

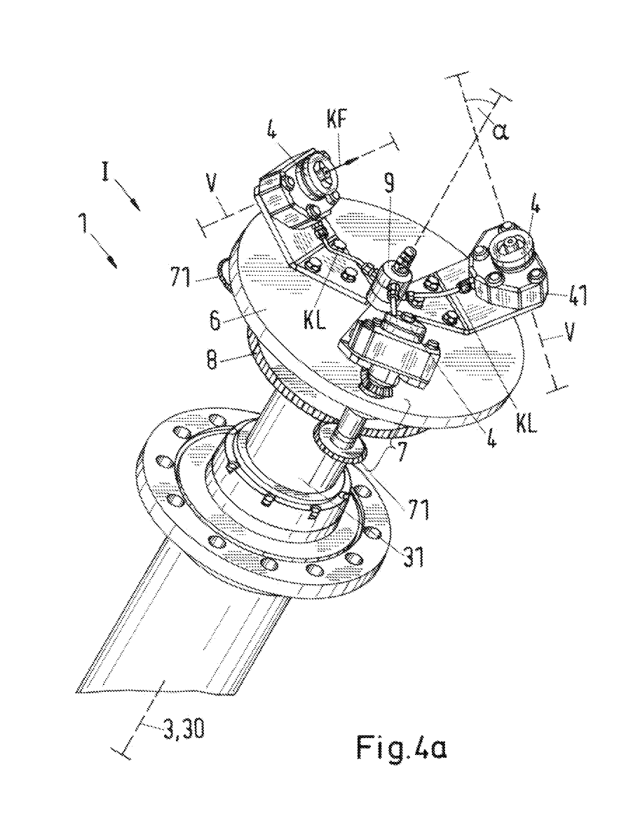

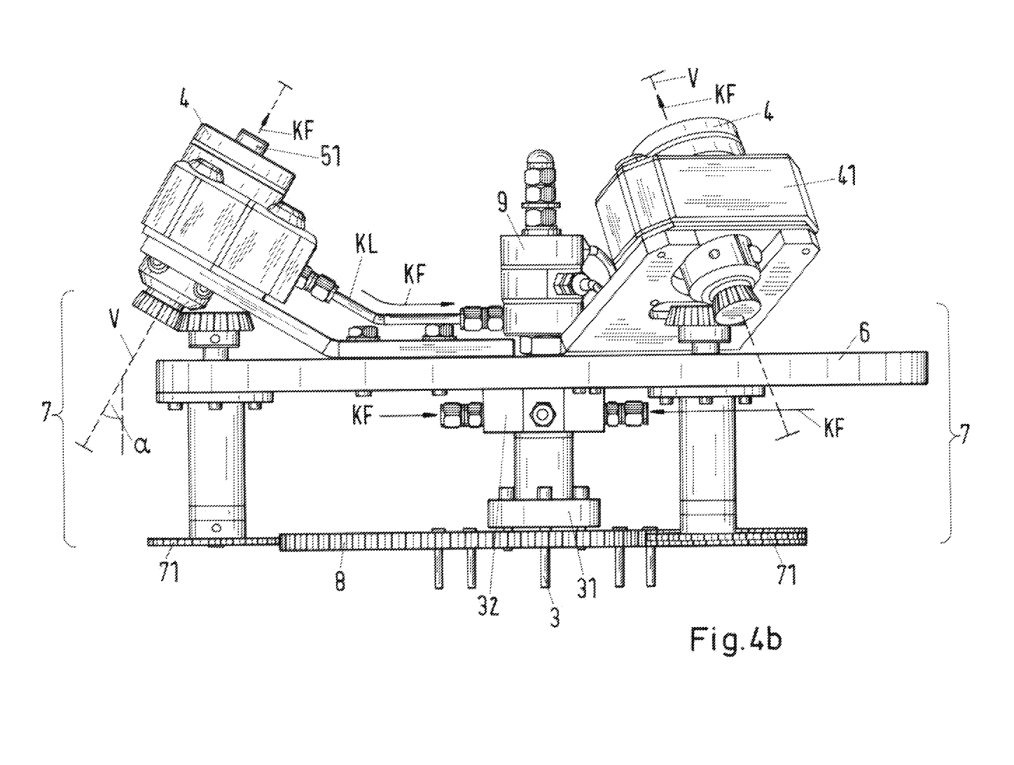

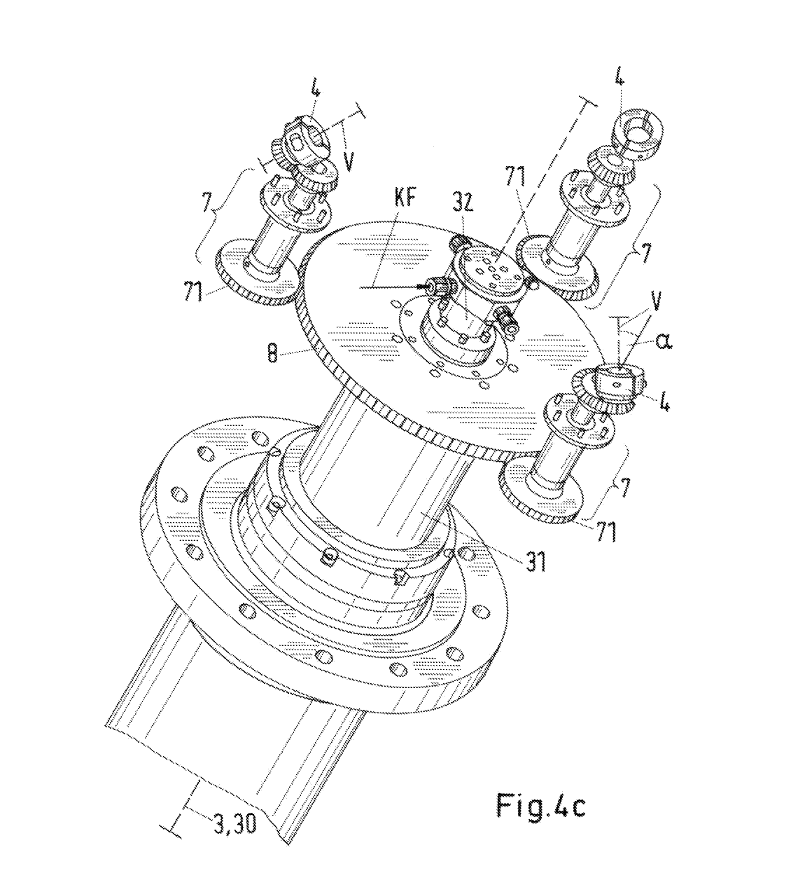

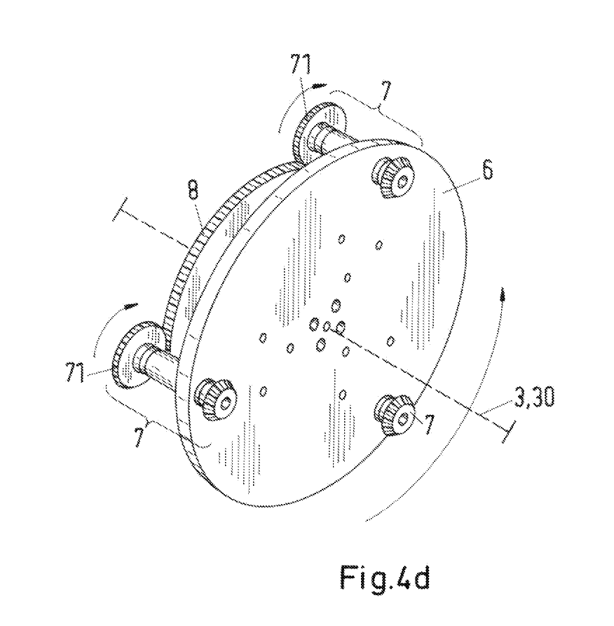

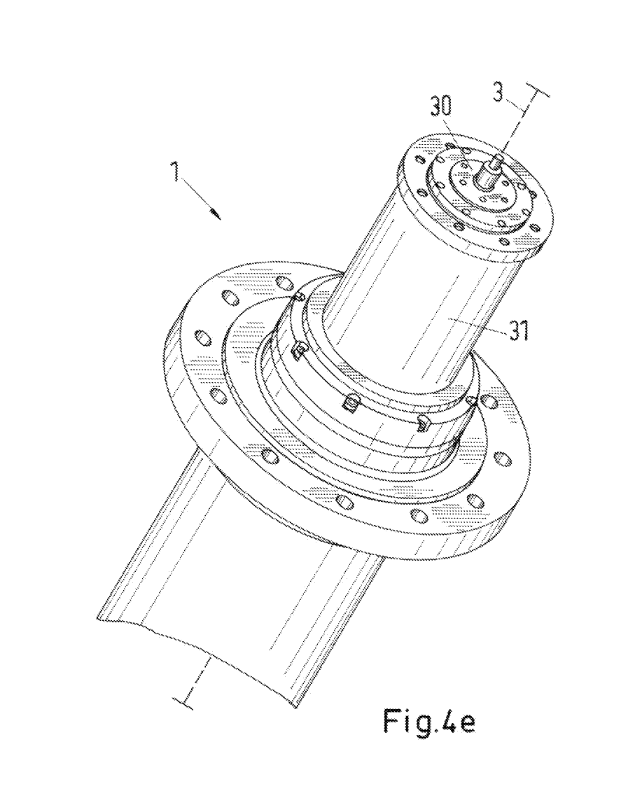

FIG. 4a the embodiment of FIG. 3 without encapsulation;

FIG. 4b a view onto the embodiment of FIG. 4a from the direction I in accordance with FIG. 4a;

FIG. 4c FIG. 4a and/or FIG. 4b in a perspective view without a base plate;

FIG. 4d base plate in drive direction in accordance with FIG. 4a and/or FIG. 4b;

FIG. 4e shaft jacket with main drive axle;

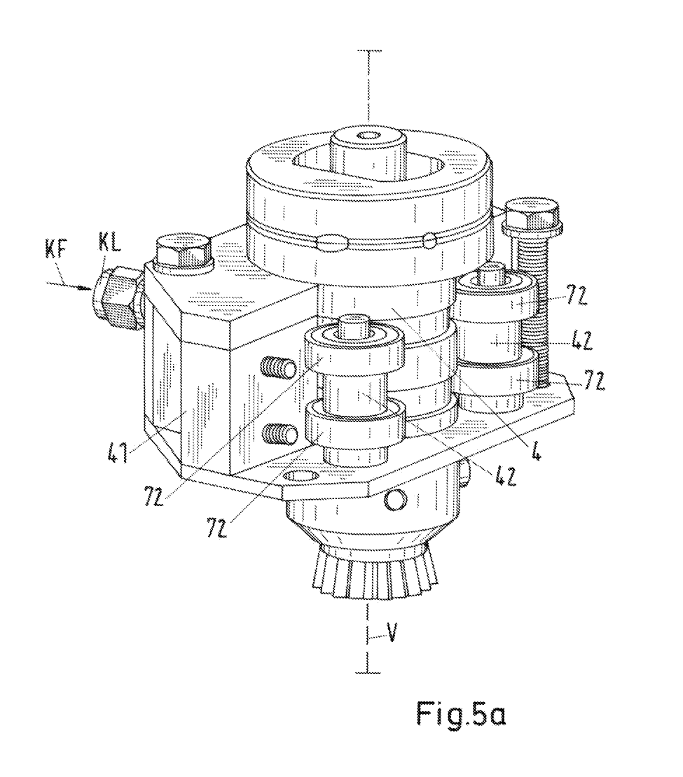

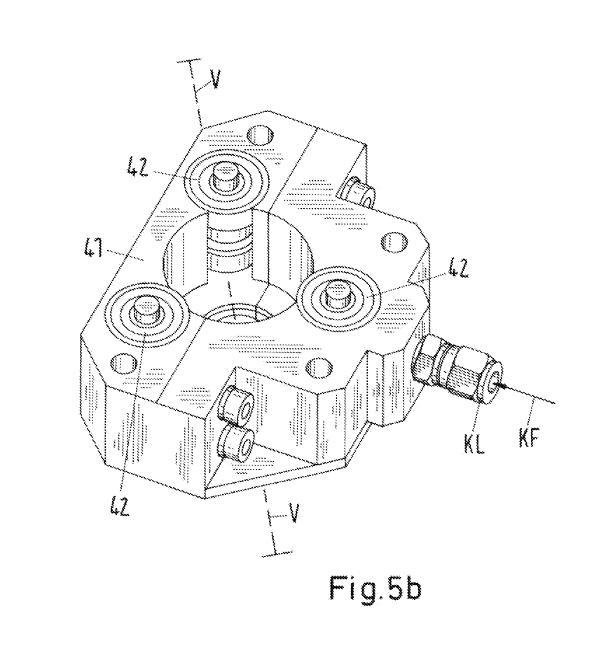

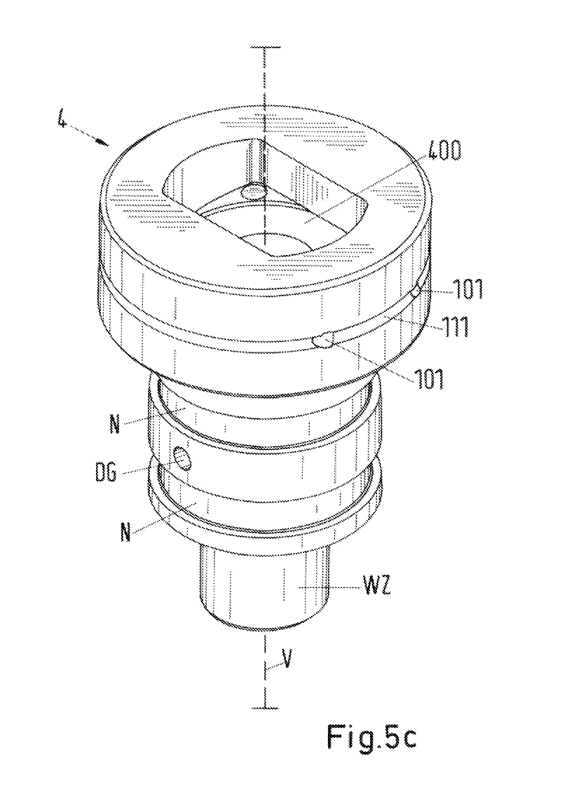

FIG. 5a setup of a bearing housing with connection elements in a perspective view;

FIG. 5b bearing housing in accordance with FIG. 5a without a connection element;

FIG. 5c a ceramic connection element;

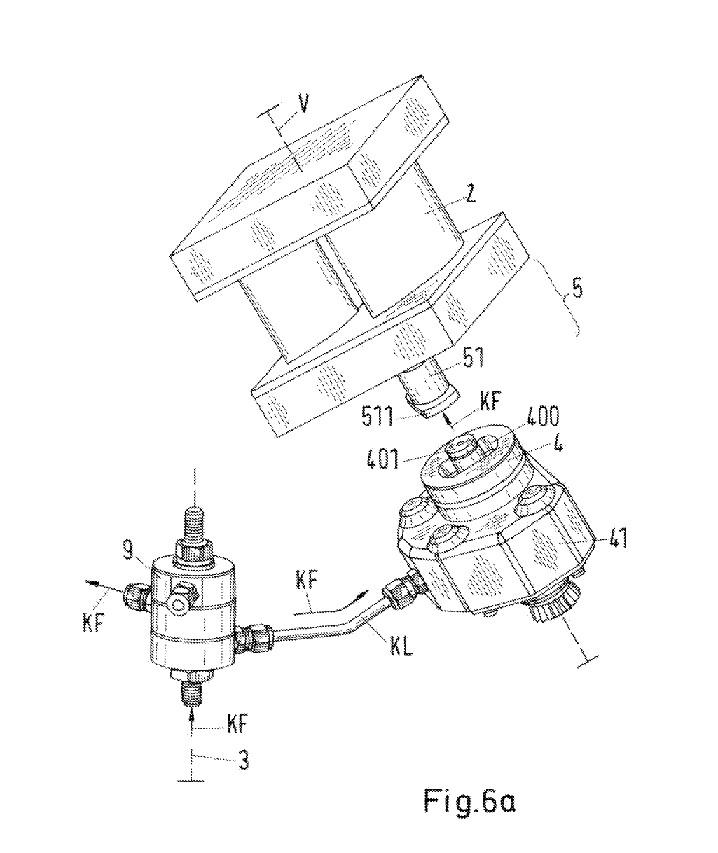

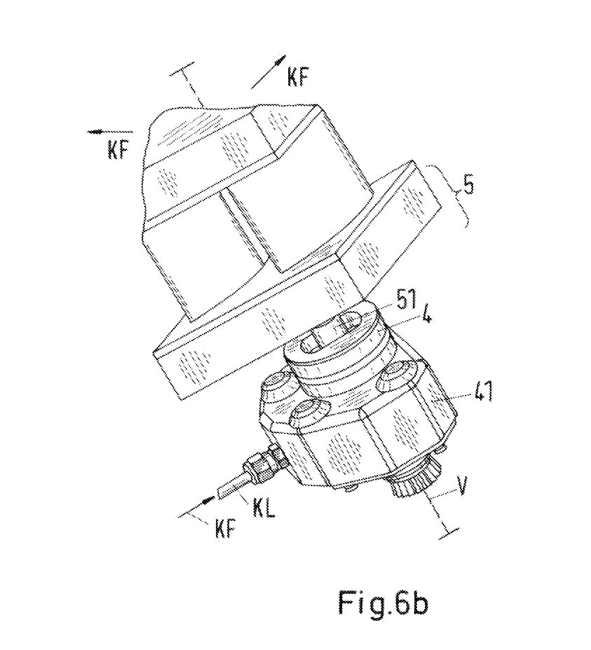

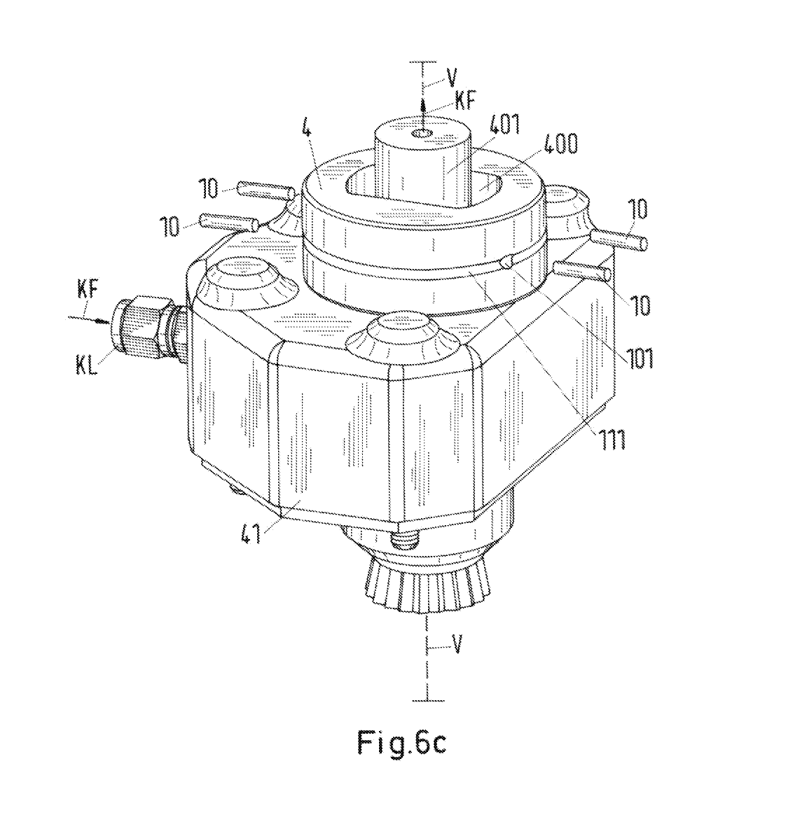

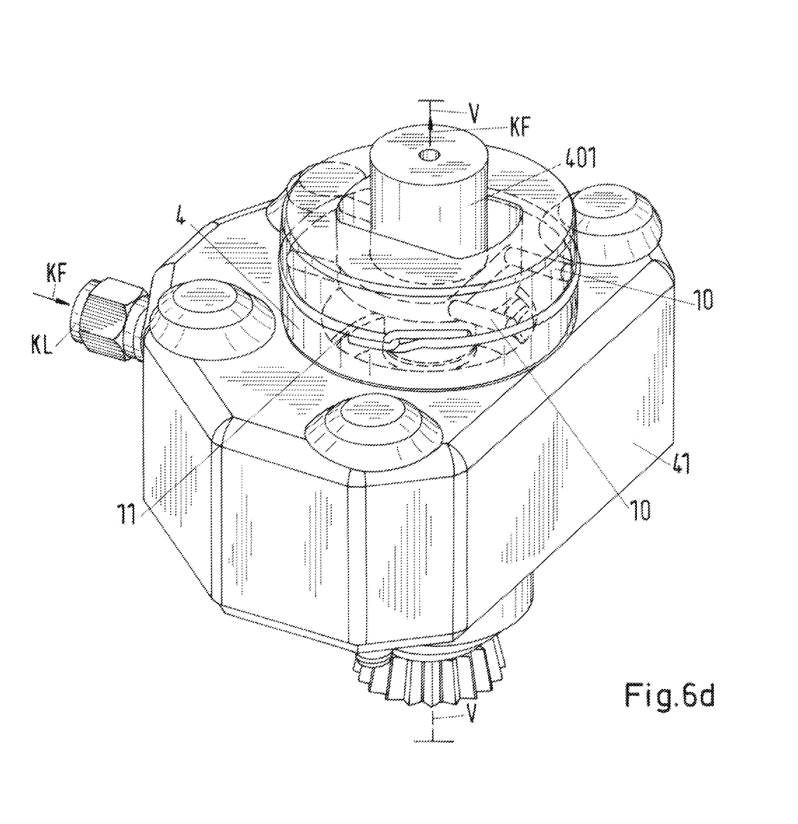

FIG. 6a manufacture of the plug and rotate connection between the substrate holder and the connection element;

FIG. 6b plug and rotate connection between substrate holder and connection element;

FIG. 6c security against rotation of the plug and rotate connection by means of a locking pin;

FIG. 6d security against rotation of the plug and rotate connection in a partially transparent view of the connection element;

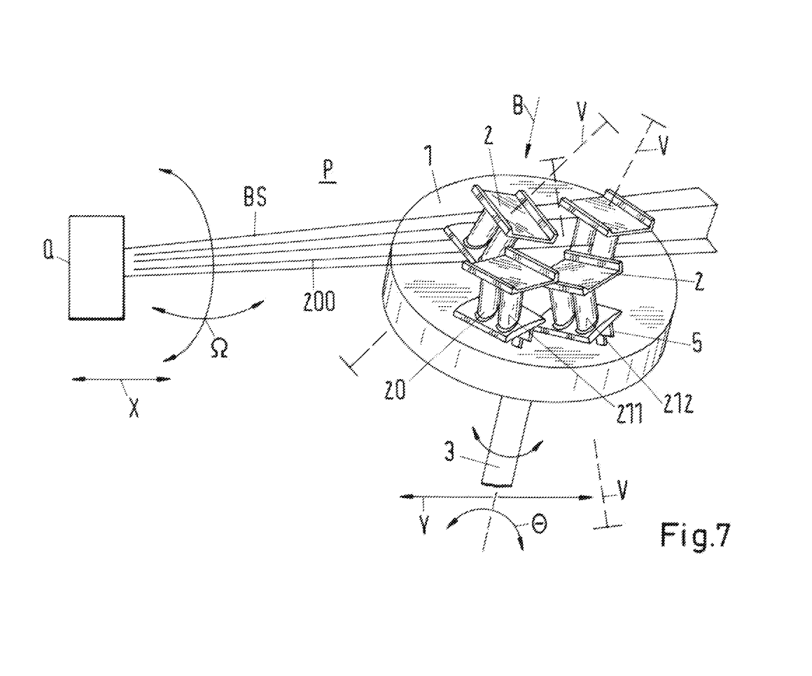

FIG. 7 a method in accordance with the invention for the simultaneous coating of several turbine vanes; and

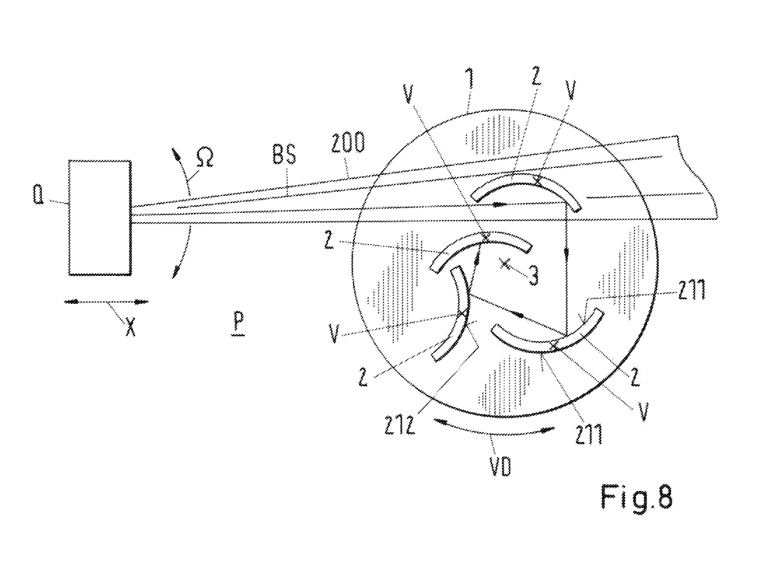

FIG. 8 a view of the embodiment of FIG. 7 from the viewing direction B.

FIG. 1 was already described in the introduction during the discussion of the prior art, so that the discussion can directly start with the embodiments in accordance with the invention according to FIG. 2 to FIG. 8 at this point.

With reference to FIG. 2a and FIG. 2b initially a first very simple embodiment of a component manipulator in accordance with the invention will be illustrated which in the following will be referred to generally with the reference numeral 1. The embodiment according to FIG. 2a is shown in the demounted state in FIG. 2b for emphasizing the function of the plug and rotate connection, this means that the plug and rotate connection is released between a substrate holder 5 and a connection element 4 in FIG. 2b, the connection element 51 is pulled out of the connection element 4.

The simple embodiment of a component manipulator 1 in accordance with the invention according to FIG. 2a and FIG. 2b only allows the reception of a single substrate holder 5 with a substrate 2 for the dynamic positioning of a substrate 2 to be treated in a thermal treatment process. In this very simple embodiment the component manipulator includes a main drive axle 30 rotatable about a main rotary axis 3, a ceramic connection element 4 and a substrate holder 5 connectable to the connection element 4 as essential elements. In accordance with the present invention the ceramic connection element 4 is connected to the connection segment 51 of the substrate holder 5 in a pull-resistant and rotationally fixed manner by means of a plug and rotate connection with regard to a connection axis V of the plug and rotate connection such that the substrate holder 5 is arranged rotatable about the connection axis V.

With reference to FIG. 3 to FIG. 6d an embodiment particularly relevant for practice of a component manipulator in accordance with the invention will now be presented.

The component manipulator 1 in accordance with the invention according to FIG. 3 for the dynamic positioning of a substrate 2 to be treated in a thermal treatment process, in this example a double turbine vane 2, includes a main drive axle 30 rotatable about a main rotary axis 3, a connection element 4 and a substrate holder 5 connectable to the connection element 4. In this respect in accordance with the invention the connection element 4 is a ceramic connection element 4, wherein a connection segment 51 of the substrate holder 5 is connected to the connection element 4 in a pull-resistant and rotationally fixed manner with regard to a connection axis V, by means of a plug and rotate connection. In this respect each connection axis V of the plug and rotate direction is tilted at a predefinable angle of tilt a with regard to the main rotary axis 3, wherein the angle of tilt α in practice is generally larger or smaller than 90° and in a preferred embodiment amounts to approximately 30°. In this respect it is preferred if each individual substrate holder 5 is rotatable about its connection axis V in the operating state and that all substrate holders 5 are commonly rotatable about the main rotary axis 3 via the main drive axle 30.

As can clearly be seen, a plurality of connection elements 4 are eccentrically provided at the base plate 6 with regard to the main rotary axis 3 for the reception of several substrate holders 5.

As will be explained in more detail in the following with reference to the detailed drawing, the connection element 4 is encapsulated in a capsule 12, for example, for protection against temperature radiation, for protection against a coating beam BS not illustrated in this example, or for protection against other damaging influences which could influence the connection element 4 in the operating state.

In this respect the capsule 12 accommodates a base plate 6 rotationally fixedly connected to the main drive axle 30 which is covered by the capsule 12 in FIG. 2 and for this reason cannot be seen as essential elements for the reception of the connection element 4 with the substrate holder 5.

Also covered by the capsule 12 and for this reason not visible in FIG. 3 is the base plate 6 which is rotationally fixedly connected to the main drive axis 3 via a connection element 32 for the supply of a coolant fluid KF and the connection elements 4 are in effective connection with a contact element 8 for the rotation of the substrate holder 5 by means of a drive unit 7 also located in the capsule 12, this means that, in particular the main drive axle 30 is rotatably arranged with regard to the contact element 8, wherein the contact element 8 is particularly preferably a toothed wheel arranged at a shaft jacked 31 stationary with regard to the main drive axle 30 which is toothed for the drive of the connection element 4 by means of the drive unit 7.

The components of the embodiment of a component manipulator 1 in accordance with the invention according to FIG. 3 and FIG. 2, insofar as they are present in the embodiment of FIG. 2 are described, in detail with reference to the following FIG. 4a to FIG. 4e.

With reference to FIG. 4a the embodiment of FIG. 3 is presented without encapsulation, this means it is shown with a removed capsule 12, so that the components in the interior of the capsule 12, as well as their cooperation can be better recognized. The substrate holder 5 with the substrate 2 is removed also for reasons of clarity.

As one can initially clearly see the main drive axle 30 is rotatable about the main rotary axis 3 which is guided by a non-rotary shaft jacket 31, i.e. by a stationary shaft jacket 31 with regard to the main drive axle 30. In this respect the main drive axle 30 is displaced into rotation in the operating state by a non-illustrated drive, for example, by a suitable electric motor or a hydraulic motor or pneumatic motor or any other suitable drive.

The contact element 8 is arranged at the shaft jacket 31, in which the main drive axle 30 is guided as mentioned and the contact element 8 is rotationally fixedly connected to the shaft jacket. Thus, in this example the contact element 8 is a toothed wheel arranged at the shaft jacket 31 stationary with regard to the main drive axle 30 which is toothed for the drive of the connection element 4 by means of the drive unit 7.

The three connection elements 4 which are respectively arranged in a bearing housing 41 are provided at the base plate 6.

The base plate 6 is rotationally fixedly connected to the main drive axle 30 by means of a connection element 32 not visible in FIG. 4a, so that the base plate 6 can be displaced into rotation by the main drive axle 30 about the main rotary axis 3.

Since the connection elements 4 are respectively in rotationally fixed engagement with the contact element 8 via the drive unit 7, which for its part is respectively in rotationally fixed engagement with the contact element 8 designed as a stationary toothed wheel with a toothed wheel 71, the ceramic connection elements 4 are also displaced into rotation on rotation of the base plate 6 with regard to the stationary contact element 8. This type of drive, which in principle can be a very simple transmission, is known to the person of ordinary skill in the art from other applications and the function of the rotary drive of the connection element 4 is thus self-explanatory to the person of ordinary skill in the art from FIG. 4a.

As can also be recognized, the cooling distributor 9 arranged at the base plate 6 is respectively connected in line connection via connections at the bearing housings 41 to the connection elements 4 via separate cooling lines KL.

As will be explained later on in detail, the cooling distribution 9 is for example, centrally supplied with a cooling fluid KF via the main drive axle 30, or as is illustrated in FIG. 4b via supply openings at the connection element 32, which cooling fluid KF can then be guided further for the cooling of the substrate holder 5 and/or the substrates 2 at the connection elements 4 via the cooling lines KL. In this respect, any suitable cooling fluid comes into question as a cooling fluid KF, in particular a gas such as nitrogen or a noble gas or any other suitable gas-like or liquid cooling fluid KF suitable for the corresponding machining process.

In this respect it is generally also possible that the base plate 6 is also cooled either by means of the cooling fluid KF or, however, additional units are provided for the cooling of the base plate 6 which units cool the base plate 6 by means of a further cooling fluid, for example, water or a suitable gas.

FIG. 4b once again shows the embodiment of FIG. 4a for purposes of clarification, this time in a view from the direction I in accordance with FIG. 4a. In this side view the connection element 32 is now also clearly seen via which the cooling fluid is supplied to the cooling distributor 9 via lateral supply openings.

In this example the mode of operation of the drive mechanism can also be seen very clearly. The contact element 8 designed as a toothed wheel is rotationally fixedly connected to the stationary axle shaft with screws. The connection element 32 is also screwed to the stationary axle shaft 31 and/or to the stationary contact element 8, so that also the connection element 32 is stationary with regard to the main drive axle 30 and/or or with regard to the base plate 6. In this respect the cooling distributor 9 is rotationally fixedly connected to the rotatable base plate 6 and rotates with this in the operating state. In this respect the cooling fluid KF is supplied from the stationary connection element to the rotating cooling distributor via a central line, by means of which the cooling distributor 9 in a connection element 32 are conductively connected but not rotationally fixedly connected.

FIG. 4a and/or FIG. 4b are shown again for a better understanding of the previously described drive mechanism for the drive of the connection element 4 via the toothed wheels 71 without a base plate 6 in a perspective view in FIG. 4c.

FIG. 4d and FIG. 4e both finally show the base plate 6 with a drive unit 7 and/or the stationary axle shaft 31 having the main drive axle 30 in accordance with FIG. 4a and/or FIG. 4b again separately respectively in detail.

As can be seen from FIG. 4d the base plate 6 is rotatably arranged about the main rotary axis 3, wherein the toothed wheels 71 of the driving unit 7 are in engagement with the toothed wheel shaped contact element 8, so that a rotation of the base plate 6 about the main rotary axis 3 displaces the non-illustrated connection elements 4 into rotation about the connection axis V.

The setup and function of the main drive axle 30 can clearly be seen from FIG. 4e which is arranged within the stationary shaft jacket 31 rotatable about the main rotary axis 3.

With reference to FIG. 5a the setup of a bearing housing with connection elements is illustrated schematically in a perspective view with partially cut open housings.

As can clearly be seen the connection element 4 is supported in the bearing housing 41 by bearing elements 42, wherein three bearing elements 42 are provided in the bearing housing 41 which form a three point bearing. Only two bearing elements can be seen in the cut open region of the bearing housing 41. The third bearing element cannot be seen in FIG. 5a, as it is located beneath the part of the bearing housing 41 which is not cut open. The support of the connection element 4 via three times two bearing rollers 72 has the significant advantage that the play between the connection element 4 and the bearing rollers 72 is well definable. Furthermore, comparatively small contact surfaces between the connection element 4 and the bearing rollers 72 are defined, so that comparatively little heat is transferred and that these bearings can also be held small which in turn saves cost. In this connection the bearing elements 42 are manufactured for operating ranges of up to approximately 500° C. from a combination of CrNi with a ceramic. The temperatures up to approximately 800° C., for example, a Si₃N₄ ceramic can advantageously be used for the bearing elements 42. Principally, also Al₂O₃ comes into question as a material for the bearings, wherein even temperatures of up to 1900° C. are possible.

Necessary seals, for example, at the bearing or at the safety tape 11 described further down can preferably be manufactured from a needle fleece, for example, a needle fleece 3.5 mm, which enables operation temperatures of up to 1100° C. without a problem.

In this respect the bearing elements 42 are brought into indirect contact with the cooling fluid KF and can thus be cooled with the cooling fluid KF via the cooling lines KL.

FIG. 5b shows the bearing housing 41 in accordance with FIG. 5a without connection element 4 for a better understanding. The three bearing elements 42 which form a three point bearing for the connection element 4 are clearly shown. In this respect the bearing housing 41 can, for example, be cladded with a needle fleece for protection against heat influences which also allows high operating temperatures of up to, for example, 1100° C.

FIG. 5c shows a connection element 4 for use in the bearing housing 41. The reception grooves N for the reception of the bearing rollers 72 can clearly be seen. The through going opening DG through which the cooling fluid KF can be guided into the interior of the connection element 4 can also be clearly seen. The lower region WZ of the connection element with regard to the drawing serves for the reception of a toothed wheel which is preferably made of metal and which brings about the coupling to the drive unit 7. In this respect the connection element is, for example, manufactured from Al₂O₂, SiO₂ or a different suitable technical ceramic. FIG. 5c. The more or less rectangular opening 500 in the upper region of the connection element 4 in accordance with the illustration can clearly be seen, which opening 400 serves for the reception of the connection segment 51 of the substrate holder 5 and therefore for the formation of the plug and rotate connection between the substrate holder 5 and the connection element 4.

Bores 101 for the ceramic locking pins of the security against rotation 10, as well as the safety groove 111 for the safety type 11 for securing the ceramic locking pins into the bores 101 can also be clearly recognized, this will be referred to in detail in the following FIGS. 6a to 6d.

With reference to FIG. 6a it should be emphasized how the plug and rotate connection is manufactured between the connection segment 51 of the substrate holder 5 and the connection element 4. As was already mentioned the connection element has an, for example, approximately rectangular opening 400 into which the connection element can be introduced. Wherein the opening 400 can naturally also have any other suitable shape. In this respect the connection element 51 also has an approximately rectangular closure part 511, and/or any other type of suitable form, which allows to form fittingly introduce the closure part 511 in a certain orientation into the opening 400 of the connection element 4. In this respect, the connection part 51 is designed as hollow in the present example, so that on introduction into the opening 400 it can be received in a position by the guide pin 401. The guide pin 401 can, for example, be composed of a SiO₂ (fused quartz) or of an Al₂O₃ material or any other high temperature resistant material. When the connection part 51 is introduced at a predefined depth into the opening 400 the substrate holder 5 and/or the connection part 51 is turned about a certain angle, for example, of about 90° or of 180° or of any different angle, wherein the closure part 511 is interlocked with a closure groove in the interior of the opening 400 in a manner known per se, so that the connection part 51 is fixedly anchored into the opening 400. This means that the connection part 51 is essentially no longer movable in the direction of the connection axis. This state is illustrated in FIG. 6b.

As can also be seen from FIG. 6a, the guide pin 401 has a central bore, via which the cooling fluid KF can be guided into the substrate holder 5 via the connection part 51. In this special embodiment in accordance with FIG. 6b the substrate holder 5 is configured such that the cooling fluid KF is guided further into an interior of the substrate 2 which in the present example is a turbine vane and thereby cools the substrate 2, for example, during a thermal coating process. The cooling fluid KF flows through the substrate 2 and flows, as should be indicated by the two arrows KF, finally from the substrate 2 into the environment, for example, into the process chamber in which the substrate 2 is currently being coated.

When, for example, the substrates 2 to be coated are turbine vanes, then cooling bores are frequently designed within the turbine vanes through which a cooling gas is frequently guided in the operating state of the turbine vanes, so that the vanes are better cooled. It is naturally understood that these cooling bores are not allowed to be closed by coating material during the coating process. For this reason, the cooling fluid KF is preferably carried away via the aforementioned cooling bores during a coating process in accordance with the invention which has the positive effect that the cooling fluid KF flowing out of the cooling bores of the turbine vane keeps these free from coating material.

It is clear that the connection part 51 only has to be secured against rotation about the connection axis V in the opening 400 this will be briefly explained with reference to FIG. 6c. Otherwise it could happen that the connection part 51 rotates in the opening 400 such that it can glide out of the opening 400 again.

Radial bores 101 are provided at the connection element 4 and at the connection part 51 in order to prevent a rotation of the connection part 51, which bores, in the in-built state of the connection part 51 in the opening 400, correspond to one another such that a security against rotation 10, for example, in the form of a metallic or a ceramic locking pin can be inserted into the bores 101 of the connection element 4 and the connection part 51, so that these locking pins prevent a rotation about the connection axis V of the connection part 51 with regard to the connection element 4. The locking pins can, for example, be manufactured from a CrNi steel or any other suitable material.

In FIG. 6d in which an upper part of the connection element 4 is transparently illustrated in accordance with the illustration, it can clearly be seen how the security against rotation 10, i.e. the locking pins 10 can secure against rotation. So that the locking pins are not released from the radial bores in the operating state, i.e. do not slide out, the locking pins are also secured with a safety tape 11 in accordance with FIG. 6d which is provided in the circumferential direction about the connection element 4 in the safety groove 111 and thereby effectively prevents a radial displacement of the locking pins 10.

It is naturally understood that depending on the application of a component manipulator 1 in accordance with the invention either only one or several substrate holders 5 are arranged at a connection element 4, for example, in accordance with FIG. 6b at a rotatable connection element 4, and therefore are additionally rotatable about the connection axis V, and all further substrate holders are substrate holders known per se which are simply arranged rotationally fixedly with regard to the component manipulator 1, i.e. are not additionally rotatable about a connection axis V. Or, however, which is the preferred case in practice, all substrate holders 5, are arranged at a rotatable connection element 4 and therefore are additionally rotatable about the connection axis V, for example, in accordance with FIG. 6b.

In FIG. 7 respectively in FIG. 8 a method in accordance with the invention for the simultaneous coating of several substrates 2, in the present example turbine vanes 2, is/are schematically illustrated by means of a component manipulator 1 in accordance with the invention. For reasons of clarity the particulars of the component manipulator in accordance with the invention were omitted in the illustration of FIG. 7 and FIG. 8. The component manipulator 1 of FIG. 7 respectively FIG. 8 can, for example, be a component manipulator in accordance with FIG. 3, wherein instead of three substrates 2, for example, four substrates 2 are simultaneously coated in this example.

The turbine vanes 2 in accordance with FIG. 7 respectively FIG. 8 are so-called double vanes 2 known per se for highly loaded airplane turbines. For reasons of clarity the process chamber 2 was not illustrated in detail and four turbine vanes 2 are shown on the component manipulator 1 by way of example. In this respect FIG. 8 is a view of FIG. 7 from the viewing direction B and merely serves for a better understanding of the mechanism of reflection of the coating material 200. For this reason the following description simultaneously relates to FIG. 7 and FIG. 8.

It is naturally understood in practice that also less than four substrates 2 could be provided at the component manipulator 1. However, it is an advantage of the method in accordance with the invention, as well as of the component manipulator 1 that also more than four substrates 2 can simultaneously be coated, which makes the method of the present invention extremely efficient.

With reference to FIG. 7 therefore a preferred embodiment of a coating apparatus in accordance with the invention and/or a method in accordance with the invention for the manufacture of a functional structured layer 20 on a substrate 2 is schematically illustrated, in which method a coating material 200 is sprayed onto a surface of substrate 211, 212 of the substrate 2 in the form of a coating beam BS in a process chamber at a predefined low process pressure P by means of a plasma spray method which is the PS-PVD method described in the introduction in the present example. In this respect the coating material 200 is injected into a plasma defocusing the coating beam BS at a low process pressure P which in the present example lies at approximately 1 mbar and which is partially or completely molten there, wherein a plasma with a sufficiently high specific enthalpy is generated, so that a substantial part of the coating material 200 is transferred into the vapor phase. The substantial part of evaporated material in this example lies at above 60 percent by weight. The structured layer 20 is formed at the substrate 2. In this respect in accordance with the invention the substrate 2 to be coated is arranged at a component manipulator 1 in accordance with the invention as described above, such that a first surface 211 of the substrate 2 and a second surface 212 of the substrate 2 are aligned with regard to one another at the component manipulator 1 so that at least a part of the coating material 200 transferred into the vapor phase is deflected and/or reflected from the first surface 211 of the first substrate 2 onto the second surface 212 of the second substrate 212 on plasma spraying, so that the second surface 212 is coated by the vapor-like coating material 200 deflected and/or reflected by the first surface 211 and is simultaneously supplied with heat energy and is thus maintained at a sufficient temperature.

In this respect the process of reflection of the vapor-like coating material 200 can be particularly clearly seen in the view of FIG. 8. It can clearly be recognized how a first turbine vane 2 including the first surface 211 and the second turbine vane 2 including the second surface 212 are arranged at the component manipulator 1, so that they are aligned relative to one another, so that a part of the coating material 200 transferred into the vapor phase is deflected and/or reflected from the first surface 211 of the first substrate 21 onto the second surface 212 of the second substrate 2 on plasma spraying and this can thus also be ideally coated at shaded regions with regard to the coating beam BS.

In this respect one or more of the substrates 2, as described above, can also be additionally rotatable about the connection axis V in addition to the rotation of the component manipulator 1 about its main rotary axis 3, so that alternatively different surfaces 211, 212 are oppositely disposed from one another in a reflecting manner, so that the reflection from the first surface 211 onto the second surface 212 can take place one after the other at different angles, whereby the formed functional structured layers can be manufactured even more uniformly and in an even higher quality.

Depending on the application then either only one or several substrate holders 5 are arranged at the component manipulator 1 in accordance with the invention, for example, according to FIG. 6b on a rotatable connection element 4 and therefore additionally rotatable about the connection axis V, and all further substrate holders are substrate holders known per se which are simply rotationally fixedly arranged with regard to the component manipulator 1, i.e. are not additionally rotatable about a connection axis V. Or, however, which will be the preferred case in practice, all substrate holders 5 are arranged, for example according to FIG. 6b, at a rotatable connection element 4 and are therefore additionally rotatable about the connection axis V.

In this respect the amount of vapor-like coating material 200 which is deflected and/or reflected from the first surface 211 onto the second surface 212 can be set such that the second surface 212 is then also maintained at a predefined surface temperature and is sufficiently coated when the second surface 212 is not directly subjected to the coating beam BS, as, for example, is shown in FIGS. 7 and 8 the component manipulator 1 is rotated about the main rotary axis 3 at a predefined rotary speed VD during the coating process.

In addition to rotating the component manipulator 1 about the main rotary axis 3 and/or the substrate 2 around the connection axis V the coating beam BS can be pivoted to and fro over the substrate 2 to be coated during the coating process in the predefined angular spatial region Ω as shown in FIG. 7 and FIG. 8 by way of example, whereby an even more uniform subjection of the substrate 2 to the coating beam BS can be achieved, simultaneously the time is minimized in which a substrate 2 is not directly subjected to the coating beam BS, so that also an even more uniform tempering of the substrate 2 is achieved.

Furthermore, a separation distance between the component manipulator 1 and a plasma source Q generating the plasma in a predefined path interval X, Y in one or more spatial directions is settable in the present embodiment, in that either the plasma source Q can be displaced along its path X in one or more spatial directions and/or the position of the component manipulator can be changed in one or more spatial directions along the path Y.

Furthermore, the component manipulator 1 can be pivoted with regard to the coating beam BS in a predefined pivot region Θ in the specific embodiment of FIG. 7 respectively FIG. 8.

For example, a fine grain spray powder known per se for the formation of a thermal barrier coating on a turbine vane 2 can be used as a coating material 200, wherein the coating beam itself is operated at supersonic speed having a sonic speed which in the present example amounts to approximately 2,000 m/s, wherein shock-like waves or states can be formed in the coating beam 6. The coating beam 6 in the present example has a temperature between 6,000 K and 10,000 K.

It is naturally understood that the invention is not limited to the described embodiments and, in particular that the embodiments in accordance with the invention described in the framework of this application can naturally also be combined with one another in any suitable manner.

1. A component manipulator for the dynamic positioning of a substrate to be treated in a thermal treatment process, wherein the component manipulator includes a main drive axle rotatable about a main rotary axis, a connection element and a substrate holder connectable to the connection element, characterized in that the connection element is a ceramic connection element and a connection segment of the substrate holder is connectable to the connection element in a pull resistant and rotationally fixed manner by means of a plug and rotate connection with regard to a connection axis (V) of the plug and rotate connection and the substrate holder is arranged rotatable about the connection axis (V).

2. A component manipulator in accordance with claim 1, wherein a base plate is provided which is rotationally fixedly connected to the main drive axle for receiving the connection element with the substrate holder.

3. A component manipulator in accordance with claim 2, wherein the base plate is rotationally fixedly connected to the main drive axle via a connection element for the supply of a cooling fluid.

4. A component manipulator in accordance with claim 1, wherein a plurality of connection elements are eccentrically provided at the base plate with regard to the main rotary axis for receiving a plurality of substrate holders.

5. A component manipulator in accordance with claim 1, wherein the connection element is in operative connection with a contact element via a drive unit for the rotation of the substrate holder.

6. A component manipulator in accordance with claim 5, wherein the main drive axle is rotatably arranged with regard to the contact element.

7. A component manipulator in accordance with claim 5, wherein the contact element is a toothed wheel arranged at a shaft jacket stationary with regard to the main drive axle and which is toothed for the drive of the connection element by means of the drive unit.

8. A component manipulator in accordance with claim 1, wherein the connection axis (V) of the plug and rotate connection is tilted at a predefinable angle of tilt (α) with regard to the main rotary axis.

9. A component manipulator in accordance with claim 3, wherein the cooling fluid is suppliable to the connection element and to the connection segment of the substrate holder via a cooling distributor arranged on the base plate and a cooling line.

10. A component manipulator in accordance with claim 1, wherein the connection element is supported in a bearing housing by a bearing element, wherein three bearing elements are preferably provided in the bearing housing which form a three point bearing and wherein the bearing element can be cooled by means of an indirect contact with the cooling fluid.

11. A component manipulator in accordance with claim 1, wherein the connection element is secured against a twist with regard to the connection element by means of a security against rotation, wherein the security against rotation is a locking pin, which is secured by means of a safety tape provided at the connection element.

12. A coating method for use of a component manipulator in accordance with claim 1.

13. A coating method in accordance with claim 12 for the manufacture of a functional structured layer on a substrate, in which a coating material is sprayed onto a surface of a substrate in the form of a coating beam in a process chamber at a predefined low process pressure by means of a plasma spray method, wherein the coating material is injected into a plasma defocusing the coating beam at a low process pressure, which is less than 200 mbar, and a plasma with sufficiently high specific enthalpy is generated, so that a substantial part of the coating material, a part of at least 5 percent by weight of the amount of the coating material, is transferred into the vapor phase and the structured layer is formed on the substrate, wherein the substrate to be coated is arranged with the substrate holder rotatable about a main rotary axis such that a first surface of the substrate and a second surface of the substrate are aligned with regard to one another so that at least a part of the coating material transferred into the vapor phase is deflected from the first surface of the substrate onto the second surface of the substrate on plasma spraying.

14. A coating apparatus for carrying out a method in accordance with claim 12 for the manufacture of a functional structured layer on a substrate, which coating apparatus includes a process chamber in which a coating material is sprayable onto the surface of a substrate in the form of a coating beam at a predefinable low process pressure by means of a plasma spray method, wherein the coating material is injectable into a plasma defocusing the coating beam at a low process pressure, which is less than 200 mbar, and is partially or completely meltable there, and wherein a plasma source (Q) and/or a spray pistol including a plasma source (Q) is/are provided by means of which a plasma with a sufficiently high enthalpy is generatable, so that a substantial part of the coating material, a part of at least 5 percent by weight of the amount of the coating material, is transferable into the vapor phase and the structured layer is formable on the substrate.

15. A use of a component manipulator (1) in accordance with claim 1, wherein the substrate is in particular a turbine vane for an airplane turbine, for a gas turbine, for a vapor turbine or for a water turbine.

16. A component manipulator in accordance with claim 1, wherein the connection element is secured against a twist with regard to the connection element by means of a security against rotation, wherein the security against rotation is a metallic or a ceramic locking pin, which is secured by means of a safety tape provided at the connection element.
